(19) United States
(12) Patent Application Publication
(10) Pub. No.: US 2008/0152019 A1
(43) Pub. Date: Jun. 26, 2008

(54) METHOD FOR SYNCHRONIZING VIDEO SIGNALS AND AUDIO SIGNALS AND PLAYBACK HOST THEREOF

(76) Inventor: Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/959,477

(22) Filed: Dec. 19, 2007

(30) Foreign Application Priority Data
Dec. 22, 2006 (TW) 095148347

(51) Int. Cl. H04N 11/02; H04N 7/26

(52) U.S. Cl. 375/240.28; 375/E07.189; 375/E07.267

(57) ABSTRACT

A method for synchronizing video signals and audio signals includes: (a) receiving a video signal and an audio signal; (b) controlling a video playback device to display an image corresponding to the video signal; and (c) controlling a speaker to output sound waves corresponding to the audio signal in a delayed period so as to synchronize the video signal and the audio signal.

### BACKGROUND OF THE INVENTION

1. Field of the Invention

The present invention relates to a method for synchronizing video signals and audio signals and a playback host thereof, and more specifically, to a method for synchronizing video signals and audio signals by delaying sound waves corresponding to audio signals in a delayed period and a playback host thereof.

2. Description of the Prior Art

With quick development of multimedia playback technique, such as high power audio or high capacity DVD, a user can enjoy a movie-like audio-visual experience at home via a very big screen cast by a projector and advanced audio. An AV (Audio-Visual) segment with bigger file capacity can make its displayed image more vivid. With improvement of storage media technique, how to increase file capacity of an audio-visual segment is not a problem any more, but how to enhance playback quality of an audio-visual segment so as to meet public demand is. In general, besides file storage errors, asynchronous video signals and audio signals occur most easily while playing AV files. Therefore, how to design a good AV signal decoding device should be a concern.

Please refer to FIG. 1. FIG. 1 is a functional block diagram of a playback system 10 according to the prior art. The playback system 10 comprises a playback host 12. The playback host 12 can be a computer or a DVD (Digital Versatile Disc) player. The playback host 12 comprises an AV signal receiving module 14 for receiving a video signal and an audio signal. The AV signal receiving module 14 comprises an AV signal separation unit 16 for separating an AV signal into the video signal and the audio signal. The payback host 12 further comprises an audio signal decoding unit 18, a speaker 20, an audio signal driving module 22 connected to the audio signal decoding unit 18 and the speaker 20, a video signal decoding unit 24, a video signal compression unit 26 connected to the video signal decoding unit 24, and a first transmission module 28. The audio signal decoding unit 18 is used for decoding audio frames of the audio signal received by the AV signal receiving module 14. The speaker 20 is used for outputting sound waves corresponding to the audio signal. The audio signal driving module 22 is used for driving the speaker 20 to play the decoded audio frames in turn. The video signal decoding unit 24 is used for decoding image frames of the video signal received by the AV signal receiving module 14. The video signal compression unit 26 is used for compressing the decoded image frames into the data. The first transmission module 28 is used for transmitting the data compressed by the video signal compression unit 26.

The playback system 10 further comprises a video playback device 30. The video playback device 30 can be a projector. The video playback device 30 comprises a second transmission module 32 for receiving the data transmitted by the first transmission module 28, wherein both the first transmission module 28 and the second transmission module 32 transmit the data corresponding to the video signal via wireless transmission. The video playback device 30 further comprises a video signal decompression unit 34 connected to the second transmission module 32, a display module 36, and a video signal driving unit 38. The video signal decompression unit 34 is used for decompressing the data. The display module 36 is used for displaying an image corresponding to the data (such as displaying corresponding images on a screen). The video signal driving module 36 is used for driving the display module 36 to play the decoded image frames in turn.

More description for the playback system 10 is provided as follows. First, the AV signal receiving module 14 of the playback host 12 receives the AV signal, such as reading the video signal and the audio signal from a storage media (e.g. a DVD, a VCD, a hard disk, etc.) or receiving the AV signal compounded by the video signal and the audio signal. Afterwards, the AV signal separation unit 16 further separates the AV signal into the video signal and the audio signal. Next, the AV signal receiving module 14 transmits the audio signal to the audio signal decoding unit 18 and transmits the video signal to the video signal decoding unit 24. The audio signal comprises a plurality of audio frames, wherein each audio frame comprises a specific amount of audio signal samples, such as 8000 audio signal samples per one audio frame. The video signal comprises a plurality of video frames. The plurality of audio frames are transmitted to the audio signal decoding unit 18 in turn to be decoded. Next, the audio signal decoding unit 18 transmits the decoded audio frames to the audio signal driving unit 22 in turn. Then, the audio signal driving unit 22 transmits the decoded audio frames to the speaker 20 in turn so as to drive the speaker 20 to output the sound waves corresponding to the audio signal. Furthermore, the plurality of image frames are transmitted to the video signal decoding unit 24 to be decoded. The plurality of image frames of the video signal need to be transmitted to the video playback device 30 since the image is displayed by the video playback device 30. To reduce information capacity of the image for faster transmission, the video signal compression unit 26 compresses the decoded image frames into the data and the data is then transmitted to the second transmission module 32 of the video playback device 30 by the first transmission module 28. Finally, the video signal decompression unit 34 of the video playback device 30 decompresses the data back into the decoded image frames, and then the video signal driving unit 38 drives the display module 36 to play the decoded image frames in turn.

As mentioned above, the video frames and the audio frames are played separately. However, during the process of the first transmission module 28 of the playback host 12 transmitting the data to the second transmission module 32 of the video playback device 30, more time is required to transmit the data via wireless transmission than via wire transmission. Thus, time for transmitting the video signal from the AV signal receiving module 14 to the display module 36 (wireless transmission) is greater than time for transmitting the audio signal from the AV signal receiving module 14 to the speaker 20 (wire transmission). As a result, the playback quality of the AV signal is decreased by the said situation since the video signal and the audio signal are asynchronous.

### SUMMARY OF THE INVENTION

It is therefore a primary objective of the present invention to provide a method for synchronizing video signals and audio signals to solve the aforementioned problem.

The present invention provides a method for synchronizing video signals and audio signals comprising: (a) receiving a video signal and an audio signal; (b) controlling a video playback device to display an image corresponding to the video signal; and (c) controlling a speaker to output sound waves corresponding to the audio signal in a delayed period so as to synchronize the video signal and the audio signal.

The present invention further provides a playback host for synchronizing video signals and audio signals by delaying the audio signals, the playback host comprising an AV signal receiving module for receiving a video signal and an audio signal; a speaker; an AV synchronization control means for controlling the speaker to output sound waves corresponding to the audio signal in a delayed period; and a first transmission module for transmitting data corresponding to the video signal to a video playback device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a playback system according to the prior art.

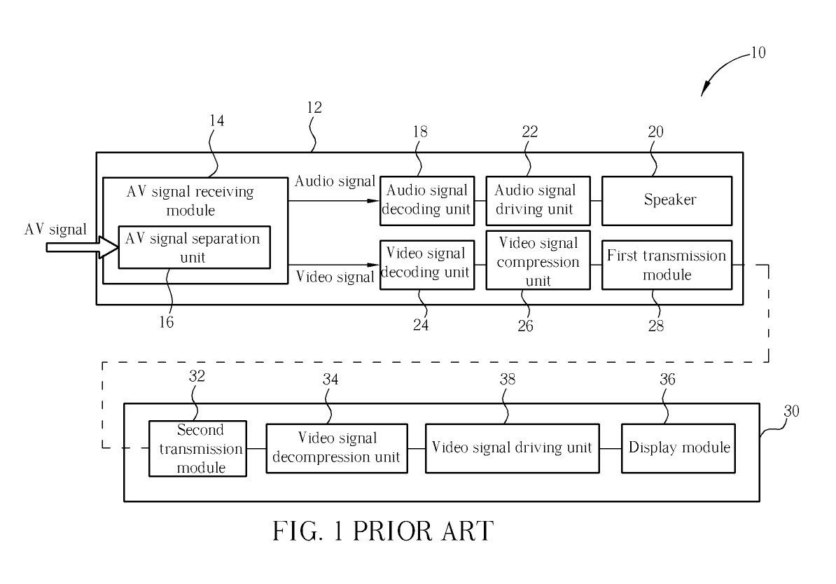

FIG. 2 is a functional block diagram of a playback system according to the present invention.

FIG. 3 is a flowchart of synchronizing the video signal and the audio signal by the playback system in FIG. 2.

### DETAILED DESCRIPTION

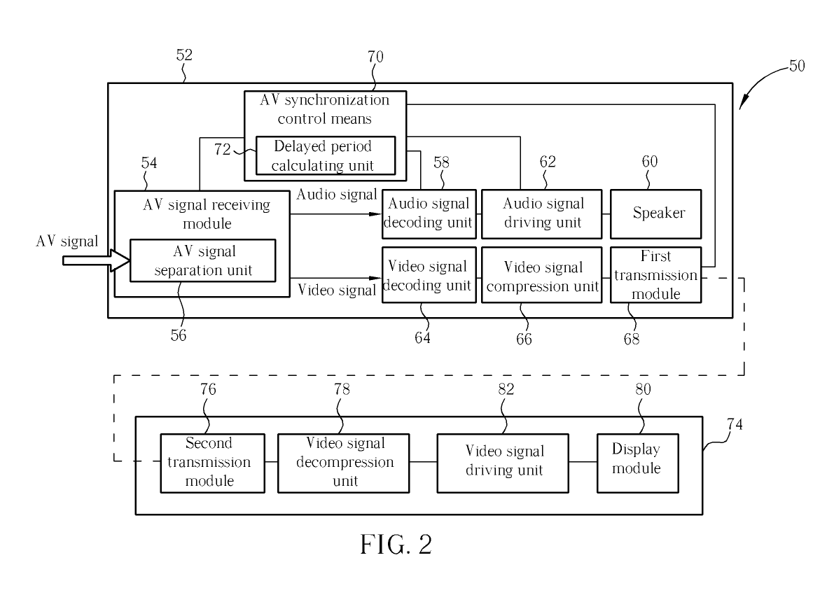

Please refer to FIG. 2. FIG. 2 is a functional block diagram of a playback system 50 according to the present invention. The playback system 50 comprises a playback host 52. The playback host 52 can be a computer or a DVD player. The playback host 52 comprises an AV signal receiving module 54 for receiving a video signal and an audio signal. The AV signal receiving module 54 comprises an AV signal separation unit 56 for separating an AV signal into the video signal and the audio signal. The playback host 52 further comprises an audio signal decoding unit 58, a speaker 60, an audio signal driving module 62 connected to the audio signal decoding unit 58 and the speaker 60, a video signal decoding unit 64, a video signal compression unit 66 connected to the video signal decoding unit 64, and a first transmission module 68. The audio signal decoding unit 58 is used for decoding audio frames of the audio signal received by the AV signal receiving module 54. The speaker 60 is used for outputting sound waves corresponding to the audio signal. The audio signal driving module 62 is used for driving the speaker 60 to play the decoded audio frames in turn. The video signal decoding unit 64 is used for decoding image frames of the video signal received by the AV signal receiving module 54. The video signal compression unit 66 is used for compressing the decoded image frames into the data. The first transmission module 68 is used for transmitting the data compressed by the video signal compression unit 66. The playback host 52 further comprises an AV synchronization control means 70 for controlling the speaker 60 to output the sound waves corresponding to the audio signal in a delayed period. The AV synchronization control means 70 comprises a delayed period calculating unit 72 for calculating the delayed period according to time stamps corresponding to the video signal.

The playback system 50 further comprises a video playback device 74. The video playback device 74 can be a projector. The video playback device 74 comprises a second transmission module 76 for receiving the data transmitted by the first transmission module 68, wherein both the first transmission module 68 and the second transmission module 76 transmit the data corresponding to the video signal via wireless transmission. The video playback device 74 further comprises a video signal decompression unit 78 connected to the second transmission module 76, a display module 80, and a video signal driving unit 82 connected to the video signal decompression unit 78 and the display module 80. The video signal decompression unit 76 is used for decompressing the data compressed by the video signal compression unit 66. The display module 80 is used for displaying an image corresponding to the decompressed data (such as displaying corresponding images on a screen). The video signal driving module 82 is used for driving the display module 80 to play the decoded image frames in turn.

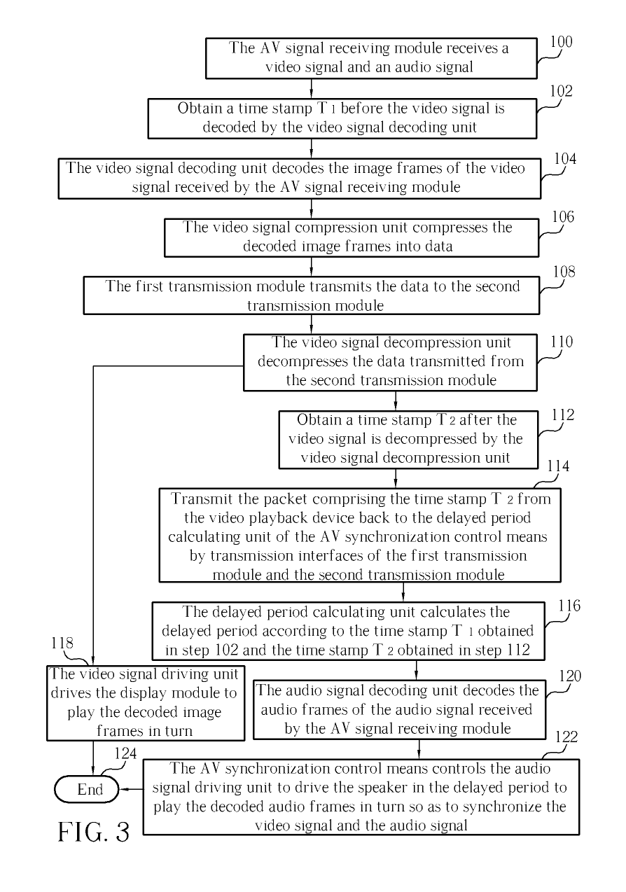

Please refer to FIG. 3. FIG. 3 is a flowchart of synchronizing the video signal and the audio signal by the playback system 50 according to the present invention. The flowchart comprises the following steps:

Step 100: The AV signal receiving module 54 of the playback host 52 receives the video signal and the audio signal;

Step 102: Obtain a time stamp T₁ before the video signal is decoded by the video signal decoding unit 64;

Step 104: The video signal decoding unit 64 decodes the video frames of the video signal received by the AV signal receiving module 54;

Step 106: The video signal compression unit 66 compresses the decoded video frames into the data;

Step 108: The first transmission module 68 of the playback host 52 transmits the data to the second transmission module 76 of the video playback device 74;

Step 110: The video signal decompression unit 78 decompresses the data transmitted from the second transmission module 76;

Step 112: Obtain a time stamp T₂ after the video signal is decompressed by the video signal decompression unit 78;

Step 114: Transmit the packet comprising the time stamp T₂ from the video playback device 74 back to the delayed period calculating unit 72 of the AV synchronization control means 70 in the playback host 52 by transmission interfaces of the first transmission module 68 and the second transmission module 76;

Step 116: The delayed period calculating unit 72 of the AV synchronization control means 70 calculates the delayed period according to the time stamp T₁ obtained in step 102 and the time stamp T₂ obtained in step 112;

Step 118: The video signal driving unit 82 drives the display module 80 to play the decoded video frames in turn;

Step 120: The audio signal decoding unit 58 decodes the audio frames of the audio signal received by the AV signal receiving module 54;

Step 122: The AV synchronization control means 70 controls the audio signal driving unit 62 to drive the speaker 60 in the delayed period to play the decoded audio frames in turn so as to synchronize the video signal and the audio signal;

Step 124: End.

More description for the said steps is provided as follows. First, the AV signal receiving module 54 of the playback host 52 receives the AV signal, such as reading the video signal and the audio signal from a storage media (e.g. a DVD, a VCD, a hard disk, etc.) or receiving the AV signal compounded by the video signal and the audio signal. Afterwards, the AV signal separation unit 56 further separates the AV signal into the video signal and the audio signal. Next, the AV signal receiving module 54 transmits the audio signal to the audio signal decoding unit 58 and transmits the video signal to the video signal decoding unit 64. The audio signal comprises a plurality of audio frames, wherein each audio frame comprises a specific amount of audio signal samples, such as 8000 audio signal samples per one audio frame. The video signal comprises a plurality of image frames. The plurality of image frames are transmitted to the video signal decoding unit 64 in turn to be decoded. The plurality of image frames of the video signal need to be transmitted to the video playback device 74 since the image is displayed by the video playback device 74. To reduce information capacity of the image for faster transmission, the video signal compression unit 66 compresses the decoded image frames into the data and the data is then transmitted to the second transmission module 76 of the video playback device 72 by the first transmission module 68. Then, the video signal decompression unit 78 of the video playback device 74 decompresses the data back into the decoded image frames. At the same time, the time stamp T₂ after the video signal is decompressed by the video signal decompression unit 78 is extracted, and the packet comprising the time stamp T₂ is then transmitted from the video playback device 74 back to the delayed period calculating unit 72 of the AV synchronization control means 70 in the playback host 52 by the transmission interfaces of the first transmission module 68 and the second transmission module 76. Subsequently, the delayed period calculating unit 72 of the AV synchronization control means 70 calculates the delayed period according to the time stamps T₁ and T₂. The delayed period can be equal to the difference of the time stamps T₁ and T₂ (i.e. T₂−T₁). In other words, the period from the time after the video signal is decoded by the video signal decoding unit 64 to the time after the video signal is decompressed by the video signal decompression unit 78 is equal to (T₂−T₁) unit time. The (T₂−T₁) unit time is spent mostly on transmitting the data compressed by the video signal compression unit 66 from the first transmission module 68 to the second transmission module 76 of the video playback device 74. That is because the information transmission traffic between the first transmission module 68 and the second transmission module 76 via wireless transmission is less than via wire transmission. Therefore, more time is required for transmitting data via wireless transmission than via wire transmission. Furthermore, time required for transmitting data between the first transmission module 68 and the second transmission module 76 via wireless transmission relates to air humidity, air density, or surrounding.

Next, the video signal driving unit 82 drives the display module 80 to play the decoded image frames of the video signal in turn. At the same time, the plurality of audio frames are transmitted to the audio signal decoding unit 58 in turn to be decoded. After the delayed period ((T₂−T₁) unit time), the AV synchronization control means 70 controls the audio signal driving unit 62 to drive the speaker 60 to play the decoded audio frames in turn. In such a manner, the image frames displayed by the display module 80 and the audio frames played by the speaker 60 can be synchronized. That is to say, the time that the speaker 60 plays an audio frame is earlier than the time that the display module 80 plays an image frame corresponding to the audio frame by (T₂−T₁) unit time. Thus, the speaker 60 must output the sound waves corresponding to the audio signal in (T₂−T₁) unit time so as to synchronize the video signal and the audio signal.

Furthermore, the delayed period can also be calculated according to the time stamp T₁ before the video signal is decoded by the video signal decoding unit 64 and a time stamp T₃ after the video signal is transmitted back to the AV synchronization control means 70 of the playback host 52 by the video playback device 74. That is to say, the delayed period is approximately equal to (T₃−T₁) unit time divided by 2 ((T₃−T₁)≈2*(T₂−T₁)). Besides the said two calculation methods, the delayed period can also be set by the user himself, or be predetermined before the playback host 52 leaves the factory.

Compared with the prior art, the present invention utilizes delaying sound waves corresponding to an audio signal to solve the problem of asynchronous video signals and audio signals, which is caused by the period of transmitting the video signal from the AV signal receiving module to the display module being greater than the period of transmitting the audio signal from the AV signal receiving module to the speaker. In such a manner, playback quality of the AV signal can be improved efficiently according to the present invention.

Those skilled in the art will readily observe that numerous modifications and alterations of the device and method may be made while retaining the teachings of the invention.

What is claimed is:

1. A playback host for synchronizing video signals and audio signals comprising:
an AV signal receiving module for receiving a video signal and an audio signal;
a speaker;
an AV synchronization control means for controlling the speaker to output sound waves corresponding to the audio signal in a delayed period; and
a first transmission module for transmitting data corresponding to the video signal to a video playback device.

2. The playback host of claim 1, wherein the AV signal receiving module further comprises an AV signal separation unit for separating an AV signal into the video signal and the audio signal.

3. The playback host of claim 1 further comprising an audio signal decoding unit for decoding the audio frames of the audio signal received by the AV signal receiving module.

4. The playback host of claim 3 further comprising an audio signal driving unit coupled to the audio signal decoding unit and the speaker for driving the speaker to play the decoded audio frames in turn.

5. The playback host of claim 1 further comprising a video signal decoding unit for decoding the video frames of the video signal received by the AV signal receiving module.

6. The playback host of claim 1 further comprising a video signal compression unit coupled to the video signal decoding unit and the first transmission module for compressing the decoded video frames into the data, and transmitting the data to the first transmission module.

7. The playback host of claim 1, wherein the AV synchronization control means comprises a delayed period calculating unit for calculating the delayed period based on time stamps corresponding to the video signal.

8. The playback host of claim 7, wherein the delayed period calculating unit is used for calculating the delayed period according to a time stamp when the video signal is received by the playback host and a time stamp when the video signal is transmitted to the video playback device.

9. The playback host of claim 5, wherein the AV synchronization control means comprises a delayed period calculating unit for calculating the delayed period according to a time stamp before the video signal is transmitted to the video signal decoding unit and a time stamp after the video signal is transmitted back to the playback host by the video playback device.

10. The playback host of claim 1, wherein the first transmission module transmits the data corresponding to the video signal to the video playback device via wireless transmission.

11. A method for synchronizing video signals and audio signals comprising:
(a) receiving a video signal and an audio signal;
(b) controlling a video playback device to display an image corresponding to the video signal; and
(c) controlling a speaker to output sound waves corresponding to the audio signal in a delayed period so as to synchronize the video signal and the audio signal.

12. The method of claim 11, wherein step (a) comprises receiving an AV signal and separating the AV signal into the video signal and the audio signal.

13. The method of claim 11 further comprising decoding the audio frames of the audio signal received in step (a).

14. The method of claim 13 further comprising driving the speaker to play the decoded audio frames in turn.

15. The method of claim 11 further comprising decoding the video frames of the video signal received in step (a).

16. The method of claim 15 further comprising:
compressing the decoded video frames into a data;
transmitting the data to the video playback device via wireless transmission;
decompressing the data by the video playback device; and
driving the video playback device to play the decoded video frames in turn.

17. The method of claim 11 further comprising calculating the delayed period based on time stamps corresponding to the video signal.

18. The method of claim 15 further comprising:
(d) obtaining a time stamp before the video signal is decoded;
(e) obtaining a time stamp after the video signal is transmitted back by the video playback device; and
(f) calculating the delayed period according to the time stamp obtained in step (d) and the time stamp obtained in step (e).
